(19) United States
(12) Patent Application Publication
(10) Pub. No.: US 2015/0084300 A1
(43) Pub. Date: Mar. 26, 2015

(54) CHASSIS MODULE AND CAMBER ANGLE ADJUSTMENT

(71) Applicant: FORD GLOBAL TECHNOLOGIES, LLC, Dearborn, MI (US)

(72) Inventors: Steven C. Hopson, Saline, MI (US); Steve Scott Allen, Saline, MI (US)

(73) Assignee: FORD GLOBAL TECHNOLOGIES, LLC, Dearborn, MI (US)

(21) Appl. No.: 14/032,487

(22) Filed: Sep. 20, 2013

(51) Int. Cl. B62D 7/18

(52) U.S. Cl. CPC B62D 7/18
USPC 280/93.512

(57) ABSTRACT

One exemplary vehicle chassis module may include a knuckle, a sub-frame and a camber control link coupled to at least one of the knuckle and the sub-frame via a slot and a surface surrounding the slot. The vehicle chassis module may also include a bolt fastener having a head corresponding with the surface, such that the bolt fastener remains at a fixed position along the slot when torque is applied to the bolt fastener and the head rotatably slides across the surface.

### BACKGROUND

Camber angle or camber is commonly known as the measurement taken between true vertical and a vertical axis of a vehicle wheel. A wheel having negative camber is presented by an upper portion of the wheel tilting laterally inward toward a longitudinal axis of the vehicle, and/or a lower portion of the wheel tilting laterally outward away from the longitudinal axis of the vehicle. A wheel having positive camber is presented by the upper portion of the wheel tilting laterally outward from the longitudinal axis of the vehicle, and/or a lower portion of the wheel tilting laterally inward toward the longitudinal axis of the vehicle. Automotive manufacturers develop and produce vehicles with recommended camber specifications, corresponding with suspension design and other wheel alignment specifications that may satisfy, for example, vehicle handling and tire wear expectations.

Many vehicles have a wheel assembly securely attached to a suspension system by adjustable fastener mechanisms for adjusting the camber. In particular, the suspension system may include a generally vertical suspension strut including a knuckle assembly operably connected to a lower portion of the strut. The knuckle may then be secured to a wheel spindle that in turn connects to the wheel. These suspension systems may include cam bolts, eccentric washers fastened to the bolts by key-and-notch features formed in the outer circumference of the bolts, and detent features formed on a sub-frame to engage the washers and move the bolt inboard or outboard for adjusting camber. These adjustable fastener mechanisms may add weight and increase costs.

It would therefore be desirable to provide chassis module and method for adjusting camber while reducing the weight and cost of these modules.

### SUMMARY

One exemplary vehicle chassis module may include a knuckle, a sub-frame and a camber control link coupled to at least one of the knuckle and the sub-frame via a slot and a surface surrounding the slot. The vehicle chassis module may also include a bolt fastener received in the slot and having a head corresponding with the surface, such that the bolt fastener remains at a fixed position along the slot when torque is applied to the bolt fastener and the head rotatably slides across the surface.

Another exemplary vehicle chassis module may include a sub-frame, a knuckle and a camber control link coupled to at least one of the sub-frame and the knuckle via a clevis. The clevis includes a pair of slots and a pair of surfaces surrounding a respective one of the slots. The vehicle chassis module may further include a bolt fastener disposed in the slots, and a nut fastener engaged to the bolt fastener to attach the camber control link to the sub-frame or the knuckle. The bolt fastener may have a head corresponding with one of the surfaces of the clevis, and the nut fastener may correspond with the other of the surfaces, such that the bolt fastener remains at a fixed position along the slots when torque is applied to at least one of the bolt fastener and the nut fastener.

An exemplary method for adjusting camber of a vehicle chassis module may include attaching the chassis module to a tooling fixture. The tooling fixture may be operated to adjust the camber of the chassis module. The method may further include rotating a head of a bolt fastener across a planar surface to hold the bolt fastener at a fixed point along a slot in the planar surface and hold the camber of the chassis module.

### BRIEF DESCRIPTION OF THE DRAWINGS

FIG. 1 is a perspective view of one exemplary chassis module having a camber control link coupled to a sub-frame to hold a wheel at a predetermined camber, without using a cam mechanism or shim mechanism at a joint between the camber control link and the sub-frame and a joint between the camber control link and the knuckle;

FIG. 2 is an enlarged view of the exemplary joint for the chassis module as taken from circle 2 shown in FIG. 1;

FIG. 3 is a top view of the chassis module shown in FIG. 1;

FIG. 4 is an enlarged view of the exemplary joint for the chassis module as taken from circle 4 shown in FIG. 3;

FIG. 5 is a cross-sectional view of the joint for the chassis module shown in FIG. 4, as taken along line 5-5;

FIG. 6 is a cross-sectional view of an exemplary joint between an outboard end of a the camber control link and a knuckle of the chassis module of FIG. 1;

FIG. 7A is an enlarged top view of another exemplary joint between an inboard end of the camber control link and the sub-frame;

FIG. 7B is an enlarged top view of yet another exemplary joint between an outboard end of the camber control link and the knuckle; and

FIG. 8 is a flowchart for one exemplary method for adjusting camber of the vehicle chassis module shown in FIG. 1.

### DETAILED DESCRIPTION

Referring now to the discussion that follows and also to the drawings, illustrative approaches are shown in detail. Although the drawings represent some possible approaches, the drawings are schematic in nature and thus not drawn to scale, with certain features exaggerated or removed to better illustrate and explain the present disclosure. Further, the descriptions set forth herein are not intended to be exhaustive or otherwise limit or restrict the claims to the precise forms and configurations shown in the drawings and disclosed in the following detailed description.

An exemplary chassis module and method for adjusting camber of the same is provided. The chassis module may have a sub-frame, a knuckle and a camber control link that is coupled to the sub-frame or the knuckle at a joint via a slot. Two examples of the joint between the sub-frame and the camber control link include the slot formed in the sub-frame or the slot formed in an inboard end of the camber control link. Two examples of the joint between camber control link and the knuckle include the slot formed in the knuckle or the slot formed in the outboard end of the camber control link. The bolt fastener may attach the camber control link to a surface surrounding the slot. The bolt fastener may have a head corresponding with the surface, such that the bolt fastener remains at a fixed position along the slot when torque is applied to the bolt fastener and the head rotatably slides across the surface.

The exemplary method for adjusting camber of a vehicle chassis module may include attaching the chassis module to a tooling fixture. The tooling fixture may be operated to adjust the camber of the chassis module. The method may further include rotating a head of a bolt fastener across a planar surface to hold the bolt fastener at a fixed point along a slot in the planar surface and hold the camber of the chassis module.

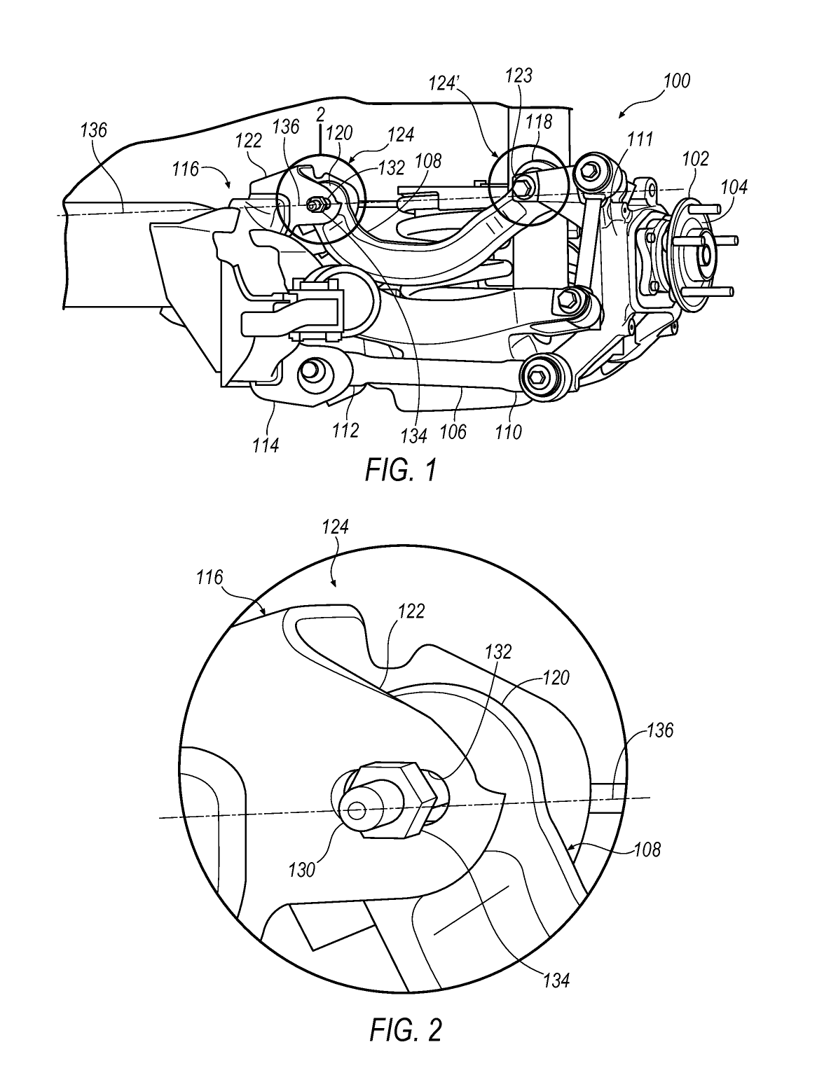

Referring to FIG. 1, one exemplary multilink chassis module 100 is illustrated. The chassis module 100 may include a wheel hub 102, upon which a wheel (not shown) may be mounted. The wheel hub 102 may have a face 104 used as a reference surface to measure camber during, for example, assembly of the chassis or maintenance of the vehicle. However, other suitable portions of the wheel hub 102 or chassis module 100 may be used to measure the camber.

With further reference to FIG. 1, the chassis module 100 may also include a lower control link 106 (hereinafter “toe control link”) and an upper control link 108 (hereinafter “camber control link”), which is spaced vertically apart from the toe control link 106. The toe control link 106 is used to adjust toe, also known as tracking. Toe is the symmetric angle that each wheel makes with the longitudinal axis of the vehicle, in contrast to steer, which is the anti-symmetric angle, i.e., both wheels point to the left or right, roughly in parallel. Positive toe, or toe in, is presented by the front of the wheel pointing in towards the longitudinal axis of the vehicle. Negative toe, or toe out, is presented by the front of the wheel pointing away from the longitudinal axis of the vehicle. Toe can be measured in linear units, at the front of the tire, or as an angular deflection.

The toe control link 106 may have an outboard end 110 operably connected to the wheel hub 102. In particular, in this example, the outboard end 110 is pivotally attached to a knuckle 111 that in turn is rotatably coupled to the wheel hub 102. The toe control link 106 may also have an inboard end 112 pivotally coupled to a lower portion 114 of a sub-frame 116, such that the toe control link 106 may point a wheel mounted to the hub 102 in a direction or heading relative to a longitudinal axis of the vehicle. In this respect, the toe control link 106 may be adjusted to change the symmetric angle that each wheel makes with respect to the longitudinal axis of the vehicle.

Referring again to FIG. 1, the camber control link 108 provides the chassis module 100 with the desired camber, e.g., within specification for the associated vehicle, by operably holding the wheel hub 102 and the sub-frame 116 in fixed positions with respect to each other. During assembly, camber may be adjusted by mounting the chassis module 100 in a tooling fixture and moving the camber control link 108 laterally inward or outward generally along an axis 136 that extends generally between the sub-frame 116 and the wheel hub 102. The camber control link 108 has an outboard end 118 pivotally attached to the knuckle 111, which in turn is rotatably coupled to the wheel hub 102. In this respect, lateral movement of the camber control link 108 pivots the knuckle 111 on the outboard end 110 of the toe control link 106 thereby adjusting the camber.

As shown in FIG. 1, the chassis module 100, in one form, may include an exemplary joint 124 between an inboard end 120 of the camber control link 108 and an upper portion 122 of the sub-frame 116, without any cam mechanism in connection therebetween. In particular, this joint 124 does not include a cam mechanism or a shim mechanism utilized for adjusting or maintaining camber, as the tooling fixture adjusts and maintains the same. The cam mechanisms and shim mechanisms typically include eccentric or lobed washers, which are rotatably carried by bolts and notch-and-key fasteners formed in the outer circumference of the bolts and inner circumference of the washers. In this respect, rotating the bolt fasteners may in turn rotate the washers and engage one or more detents formed on a sub-frame to move the bolt fastener along the slot and thus move the camber control link laterally inward or outward to adjust camber. The joint 124 does not have cam mechanisms, shim mechanisms, eccentric washers, notch-and-key fasteners, and detents on the sub-frame, and thus decreases the cost and weight of the chassis module 100, while still accurately providing camber that complies within vehicle specifications.

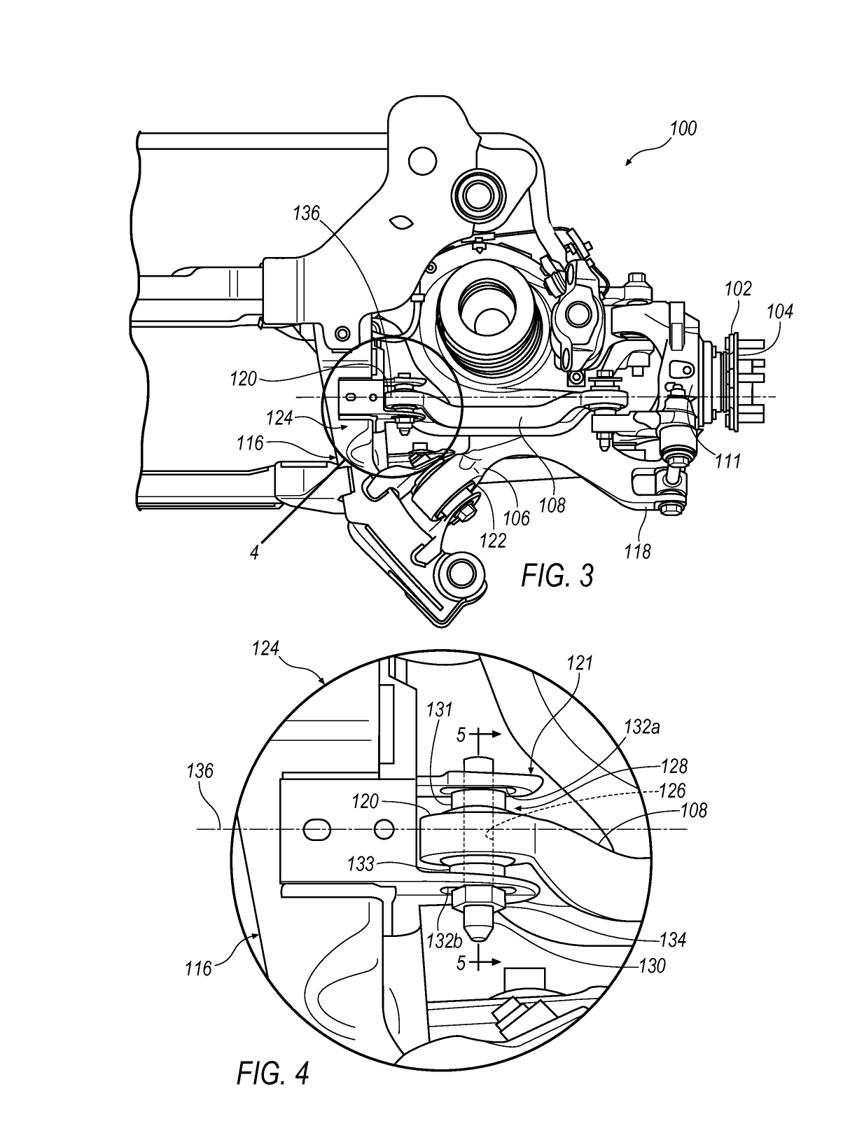

FIG. 2 shows an enlarged view of the joint 124 shown in FIG. 1. In addition, FIGS. 3 and 4 illustrate a top elevation view and an enlarged top view, respectively, of the joint 124 shown in FIG. 2. The joint 124 may be configured to permit a tooling fixture to selectively move the wheel hub 102 with respect to the sub-frame 116 and adjust camber to comply with specifications associated with the vehicle by the manufacturer. In particular, while adjusting camber, the tooling fixture moves the camber control link 108 laterally inboard or outboard along the axis 136. In this way, the tooling fixture can move the wheel hub 102 and the camber control link 108 without using any cam mechanism or shim mechanism integrated within the joint 124.

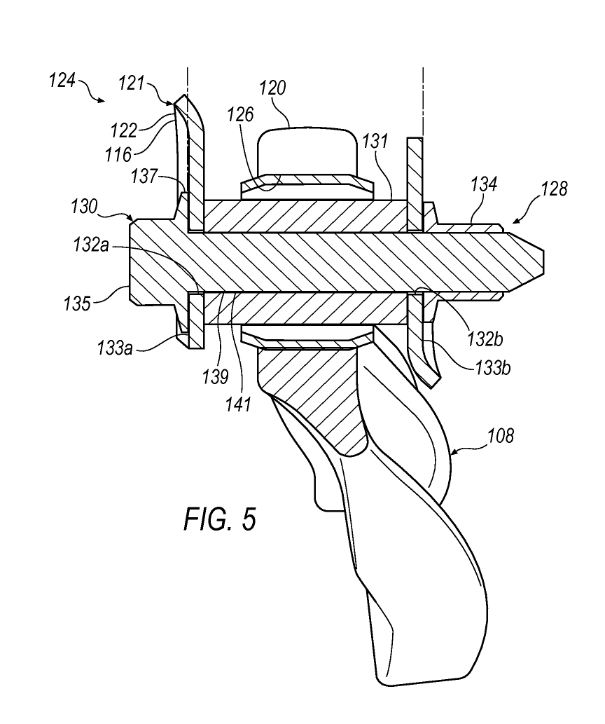

FIG. 5 illustrates a cross-sectional view of one example of the joint 124 of FIG. 4, as taken along line 5-5. The joint 124 may include an aperture 126 formed in the inboard end 120 of the camber control link 108, and elongated slots 132a, 132b formed in a clevis 121 extending from the upper portion 122 of the sub-frame 116. A rotational fastener 128 may be received in the aperture 126 and carried by the camber control link 108. In this way, the rotational fastener 128 may translate along the respective slots 132a, 132b (best shown in FIGS. 2 and 4) while the tooling fixture tilts the wheel hub 102 and/or the sub-frame 116 toward the predetermined camber angle. As shown in FIG. 5, the rotational fastener 128 in this form may be a bolt fastener 130, pin or any other suitable fastener pivotally attached to the inboard end 120 of the camber control link 108. In addition, the rotational fastener 128 may include a bushing 131 carried by the bolt fastener 130 within the aperture 126 and the clevis 121, to facilitate pivoting of the camber control link 108 on the bolt fastener 130. Further, the rotational fastener 128 may have a nut fastener 134 coupled to the bolt fastener 130 to hold the wheel hub 102 at the predetermined camber. In particular, the bolt fastener 130 and/or the nut fastener 134 may be loaded with a predetermined amount of torque to hold the bolt fastener 130 and camber control link 108 at a fixed point along the slots 132a, 132b, which in turn holds the knuckle 111 and the wheel hub 102 at fixed positions relative to the sub-frame 116 to provide the predetermined camber.

In this example, no portion of the joint 124 includes a cam washer, a cam bolt, a cam mechanism, a shim mechanism, notch-and-key fasteners between any washer and bolt, detents formed on the sub-frame for engaging cam washers, or any other cam adjusting mechanisms in connection between the inboard end 120 of the camber control link 108 and the upper portion 122 of the sub-frame 116. In this respect, the bolt fastener 130 can rotate one or more full turns while the camber control link 108 remains in a fixed position along the slots 132a, 132b. Furthermore, the sub-frame 116 has planar surfaces 133a, 133b surrounding a respective one of slots 132a, 132b. The bolt fastener 130 has a head portion 135, which corresponds with the planar surface 133a and is configured to rotate at least one full turn across the planar surface 133a. In this way, the camber control link 108 remains at a fixed position along the slots 132a, 132b when torque is applied to the nut fastener 134 and/or the head 135 causing the same to spin. Similarly, the nut fastener 134 corresponds with the planar surface 133b and is configured to rotate at least one full turn across the planar surface 133b, such that the camber control link 108 remains at a fixed position along the slots 132a, 132b when torque is applied to the nut fastener 134 and/or the head 135. In addition, as shown in FIG. 5, the head 135 has an outer diameter surface 137 extending continuously about a circumference of the head, e.g. without notches, splines or keys for attaching to a cam washer. Similarly, the bolt fastener 130 has a shaft 139 that extends from the head 135 and has a threaded profile 141 extending continuously about a circumference of the shaft from one end of the shaft 139 to the other end, e.g. without notches, splines or keys for attaching to a cam washer.

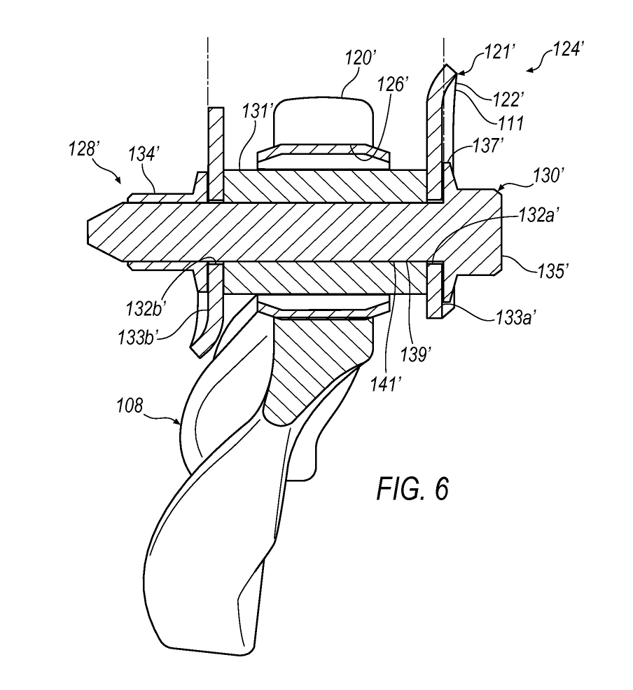

FIG. 6 is an enlarged view of an example of a joint 124′ between the knuckle 111 and the outboard end 118 of the camber control link 108. This joint 124′ is similar to the joint 124 between the inboard end 120 of camber control link 108 and the sub-frame 116, with similar components identified by the same reference numerals followed by the prime symbol (′). In particular, no portion of the joint 124′ includes a cam washer, a cam bolt, a cam mechanism, a shim mechanism, notch-and-key fasteners between any washer and bolt, detents formed on the sub-frame for engaging cam washers, or any other cam adjusting mechanisms in connection between the camber control link 108 and the knuckle 111. The joint 124′ includes an outboard bolt fastener 130′ that can rotate one or more full turns while the camber control link 108 remains in a fixed position. Furthermore, the knuckle 111 has a clevis 121′ including a pair of slots 132a′, 132b′ and planar surfaces 133a′, 133b′ surrounding a respective one of the slots 132a′, 132b′. The bolt fastener 130′ has a head portion 135′, which corresponds with the planar surface 133a′ and is configured to rotate at least one full turn across the planar surface 133a′, such that the camber control link 108 remains at a fixed position along the slots 132a′, 132b′ when torque is applied to the nut fastener 134′. Similarly, the nut fastener 134′ corresponds with the planar surface 133b′ and is configured to rotate at least one full turn across the planar surface 133b′, such that the camber control link 108 remains at a fixed position along the slots 132a′, 132b′ when torque is applied to the nut fastener 134′. In addition, the head 135′ has an outer diameter surface 137′ extending continuously about a circumference of the head, e.g., without any notches, splines or keys that could be used to mount a cam washer. Similarly, the bolt fastener 130′ has a shaft 139′ extending from the head 135′ and having a threaded profile 141′ that extends continuously about a circumference of the shaft from one end of the shaft 139′ to the other end, e.g., without any notches, splines or keys for attaching to a cam washer or other eccentric lobe.

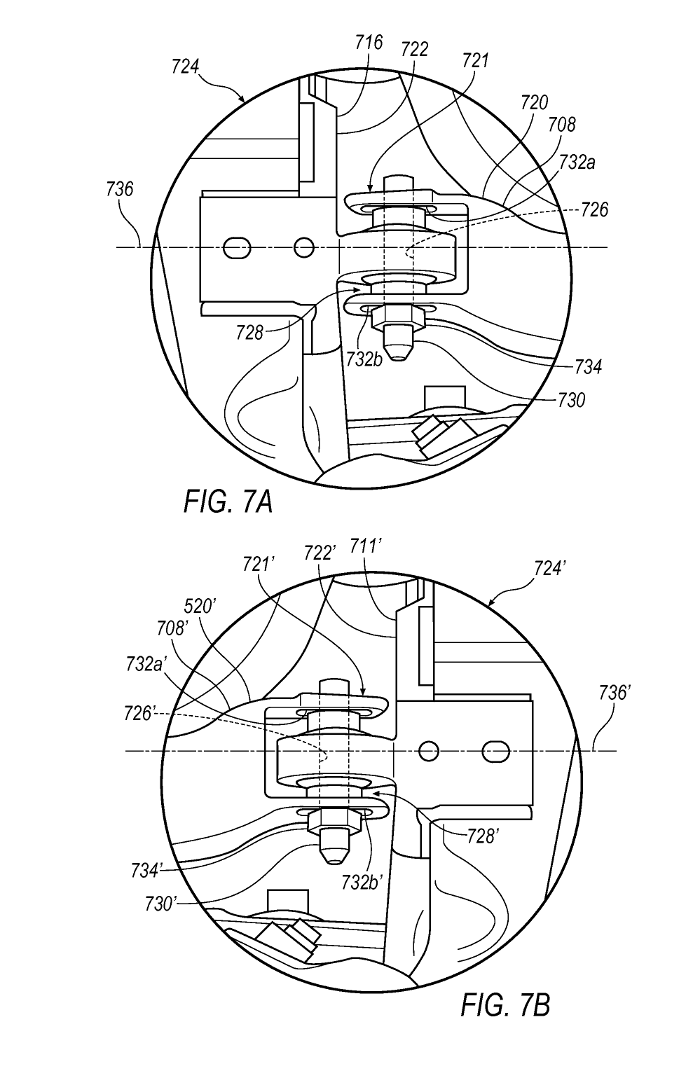

Referring to FIG. 7A, there is illustrated another exemplary joint 724 that is substantially similar to the joint 124 shown in FIG. 4, and has substantially similar components identified with corresponding reference numerals in the 700 series. However, the joint 724 in this form may include a clevis 721 extending from the inboard end 720 of a camber control link 708. The clevis may have elongated slots 732a, 732b, and an upper portion 722 of a sub-frame 716 may have an aperture 726 generally aligned with the slots 732a, 732b. A rotational fastener 728 may be received within the aperture 726 and carried by the sub-frame 716, such that the rotational fastener 728 may translate along the slots 732a, 732b while the tooling fixture tilts the wheel hub and/or the sub-frame toward the predetermined camber angle. As with the previous example, the rotational fastener 728 may be a bolt element, pin or any other suitable rotational fastener, and the rotational fastener 728 may include a nut fastener 734 to hold the wheel hub in a position for providing the predetermined camber. The nut fastener 734 may be coupled to the bolt element 730 and loaded with a predetermined amount of torque for holding the rotational fastener 728 in a fixed position within the slots 732a, 732b, and therefore holding the camber control link 708 in a fixed position relative to the sub-frame. As with the previous example, no portion of this joint 724 includes a cam washer, a cam bolt, a cam mechanism, a shim mechanism or any cam adjusting mechanism in connection between the camber control link 708 and the sub-frame 716.

Referring to FIG. 7B, there is illustrated another exemplary joint 724′ that is substantially similar to the joint 124′ shown in FIG. 6, and has substantially similar components identified with corresponding reference numerals in the 700 series. However, the joint 724′ in this form may include a clevis 721′ extending from the outboard end 718 of a camber control link 708. The clevis 721′ may include elongated slots 732a′, 732b′, and an upper portion of the knuckle 711 may include an aperture 726′ that is generally aligned with the slots 732a′, 732b′. A rotational fastener 728′ may be received within the aperture 726′ and carried by the knuckle 711, such that the rotational fastener 728′ may translate along the slots 732a′, 732b′ while the tooling fixture tilts the wheel hub and/or the sub-frame toward the predetermined camber angle. Continuing with the previous example, the rotational fastener 728′ may be a bolt element, pin or any other suitable rotational fastener, and the rotational fastener 728′ may include a nut fastener 734′ to hold the wheel hub in a position for providing the predetermined camber. The nut fastener 734′ may be coupled to the bolt element 730′ and loaded with a predetermined amount of torque for holding the rotational fastener 728′ in a fixed position within the slots 732a′, 732b′, and therefore holding the camber control link 708 in a fixed position relative to the knuckle 711. As with the previous example, no portion of this joint 724′ includes a cam washer, a cam bolt, a cam mechanism, a shim mechanism or any cam adjusting mechanism in connection between the camber control link 708 and the sub-frame 716.

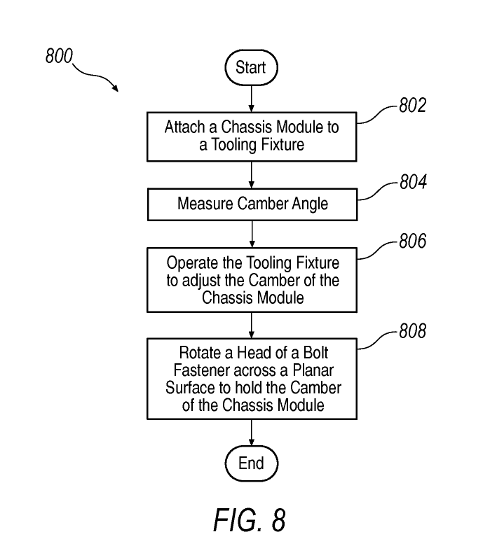

Referring to FIG. 8, there is illustrated one exemplary method 800 for adjusting camber of the chassis module 100 shown in FIG. 1 with reference to components depicted therein. The method may begin at block 802, in which the chassis module 100 is secured to a tooling fixture. In particular, in one example, a bottom portion 114 of the sub-frame 116 is spaced apart from a lower portion of the wheel hub 102 by the toe control link 106. The inboard end 112 of the toe control link 106 may be pivotally attached to the bottom portion 114 of the sub-frame 116. Further, the outboard end 110 of the toe control link 106 may be pivotally attached to the knuckle 111, which in turn is rotatably coupled to the wheel hub 102, such that the bottom portion 114 of the sub-frame 116 may be held at a substantially fixed distance from the lower portion of the wheel hub 102. In this way, the camber control link 108, which is operably coupled to the wheel hub 102, may move generally along the axis 136 to in turn pivot the wheel hub 102 relative to the outboard end 110 of the toe control link 106 and adjust the camber of the wheel. For example, this step may be accomplished by securing the sub-frame 116 to a stationary tooling fixture (not shown) and holding the sub-frame 116 in a fixed position, while the camber control link 108 and wheel hub 102 are mounted to a movable portion of the tooling fixture (not shown) or manually moved by an operator.

At step 804, the camber of a wheel may be estimated by measuring camber at the wheel hub 102, from, for example, a face of the wheel hub 102. However, the camber may instead be measured with reference to other suitable portions of the chassis module or any combination thereof. The current camber may be used to determine the deviation of the wheel from the predetermined camber angle and, therefore, the amount of adjustment to the chassis module.

At step 806, the wheel hub 102 may be tilted toward a predetermined camber angle. In particular, this step may be accomplished by using the tooling fixture to move the wheel hub 102 and camber control link 108, without any cam mechanism or shim mechanism at the joint. In this example, the tooling fixture may move the camber control link 108 toward the sub-frame 116 or the wheel hub 102, so as to pivot the wheel hub 102 toward the predetermined camber angle. Also, the rotational fastener 128 may pivotally carry the inboard end 120 of the camber control link 108. The camber control link 108 may carry the rotational fastener 128 within the elongated slots 132a, 132b in the sub-frame 116, as the camber control link 108 is moved toward the sub-frame 116 or the wheel hub 102.

At step 808, the wheel hub 102 may be held at the predetermined camber angle by, for example, attaching the rotational fastener 128 at the fixed position along the slots 132a, 132b in the sub-frame 116, which in turn holds the camber control link 108 and the wheel hub 102 a fixed position along the axis 136. This may be accomplished by engaging the nut fastener 134 with the bolt fastener 130 and loading the nut fastener 134 with a predetermined amount of torque to hold the rotational fastener 128 at the fixed point along the slot 132. This rotational fastener does not include any cam mechanism or shim mechanism.

Accordingly, it is to be understood that the above description is intended to be illustrative and not restrictive. Many embodiments and applications other than the examples provided would be apparent upon reading the above description. The scope of the invention should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the invention is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

What is claimed as new and desired to be protected by Letters Patent of the United States is:

1. A vehicle chassis module, comprising:
a knuckle;
a sub-frame;
a camber control link coupled to at least one of the knuckle and the sub-frame via a slot and a surface surrounding the slot; and
a bolt fastener having a head corresponding with the surface, such that the bolt fastener remains at a fixed position along the slot when torque is applied to the bolt fastener and the head rotatably slides across the surface.

2. The vehicle chassis module of claim 1, wherein the surface surrounding the slot is planar.

3. The vehicle chassis module of claim 2, wherein the bolt fastener is disposed in the slot, and the head of the bolt fastener is loaded onto a portion of the planar surface.

4. The vehicle chassis module of claim 1, wherein the head is configured to rotate at least one full turn across a portion of the surface.

5. The vehicle chassis module of claim 1, wherein the slot is formed in one of the sub-frame and the knuckle.

6. The vehicle chassis module of claim 5, wherein the camber control link has an aperture, and the bolt fastener is received in the aperture and the slot.

7. The vehicle chassis module of claim 1, wherein the slot is formed in one of an inboard end and an outboard end of the camber control link.

8. The vehicle chassis module of claim 7, wherein one of the sub-frame and the knuckle has an aperture, and the bolt fastener is received in the aperture and the slot.

9. The vehicle chassis module of claim 1, wherein the head has an outer diameter surface extending continuously about a circumference of the head.

10. The vehicle chassis module of claim 1, wherein the bolt fastener has a shaft extending from the head, and the shaft has a threaded profile extending continuously about a circumference of the shaft from one end of the shaft to an opposing end of the shaft.

11. A vehicle chassis module, comprising:
a sub-frame;
a knuckle;
a camber control link coupled to at least one of the sub-frame and the knuckle via a clevis, and the clevis includes a pair of slots and a pair of surfaces surrounding a respective one of the slots;
a bolt fastener disposed in the slots; and
a nut fastener engaged to the bolt fastener to attach the camber control link to one of the sub-frame and the knuckle;
wherein the bolt fastener has a head corresponding with one of the surfaces of the clevis and the nut fastener corresponds with the other of the surfaces, such that the bolt fastener remains at a fixed position along the slots when torque is applied to at least one of the bolt fastener and the nut fastener.

12. The vehicle chassis module of claim 11, wherein the clevis extends from the sub-frame.

13. The vehicle chassis module of claim 11, wherein the clevis extends from the knuckle.

14. The vehicle chassis module of claim 11, wherein the clevis extends from one of an inboard end and an outboard end of the camber control link.

15. The vehicle chassis module of claim 11, wherein the surfaces surrounding the slots are planar.

16. The vehicle chassis module of claim 11, wherein the head is configured to rotate at least one full turn across one of the surfaces.

17. The vehicle chassis module of claim 11, wherein the nut fastener is configured to rotate at least one full turn across the other of the surfaces.

18. The vehicle chassis module of claim 11, wherein the head has an outer diameter surface extending continuously about a circumference of the head.

19. The vehicle chassis module of claim 11, wherein the bolt fastener has a shaft extending from the head, and the shaft has a threaded profile extending continuously about a circumference of the shaft from one end of the shaft to an opposing end of the shaft.

20. A method for adjusting camber of a chassis module, comprising:
attaching the chassis module to a tooling fixture;
operating the tooling fixture to adjust the camber of the chassis module; and
rotating a head of a bolt fastener across a planar surface of one of a sub-frame and a knuckle to hold the bolt fastener at a fixed point along a slot in the planar surface and hold the camber of the chassis module.
